(19) United States
(12) Patent Application Publication
(10) Pub. No.: US 2016/0335640 A1
(43) Pub. Date: Nov. 17, 2016

(54) LINKING ACCOUNTS USING SURFACE REPRESENTATIONS OF GEOLOCATION HISTORY

(71) Applicant: MasterCard International Incorporated, Purchase, NY (US)

(72) Inventor: Justin Xavier Howe, San Francisco, CA (US)

(21) Appl. No.: 14/713,323

(22) Filed: May 15, 2015

(51) Int. Cl. G06Q 20/40; G06Q 40/00; H04W 4/02; G06Q 20/32

(52) U.S. Cl. CPC G06Q 20/4016; G06Q 20/3224; G06Q 40/12; H04W 4/028

(57) ABSTRACT

Systems, methods, and computer program products are provided for linking one or more geolocation devices held by an individual with a payment instrument used by the individual. A specialized computing device receives graphical representations of geolocation history associated with one or more geolocation devices transmitting recognition IDs. The specialized computing device receives a payment instrument identification and associated graphical representation of spending history, to be linked with the one or more geolocation devices. A volume difference is calculated between the graphical representation of spending history and the graphical representation of geolocation history. A determination is then made if the volume difference between the graphical representation of spending history and the exactly one graphical representation of geolocation history is below a match threshold and, if so, linking the payment instrument identification with the one or more geolocation devices transmitting the recognition IDs.

### CROSS-REFERENCE TO RELATED APPLICATIONS

This application is related to U.S. non-provisional application Ser. No. 13/920,920, “Geo-Enumerative Deviceholder Authentication” (hereinafter “GEO-ENUMERATIVE DEVICEHOLDER AUTHENTICATION”), currently published as United States Patent Application Publication 2014/0372304, and application Ser. No. 13/671,791, “Methods for Geotemporal Fingerprinting.” (hereinafter “METHODS FOR GEOTEMPORAL FINGERPRINTING”), currently issued as U.S. Pat. No. 8,924,433. The full disclosures of these applications are incorporated in their entirety herein.

### FIELD OF THE DISCLOSURE

The present disclosure relates to fraud prevention and data mining in the field of payment instrument transactions. More specifically, disclosed are a system, method, and computer program product for associating a payment instrument identification utilized by an individual with one or more geolocation devices via a comparison by a specialized computing device of one or more graphical representations of geolocation history associated with one or more geolocation devices and a graphical representation of spending history by the individual. Such system, method, and computer program product provides advantages in the fields of fraud prevention, data mining, and others without requiring explicit registration of payment instrument holders in a program to track locations of purchases.

### BACKGROUND OF THE DISCLOSURE

Payment card issuers (better referred to presently as “payment instrument issuing institutions,” thanks to a variety of new technologies for making payments including not only credit cards and debit cards, but also electronic wallets, transponder devices, near-field communication-enabled (“NFC”) smartphones, or similar presently existing or after-arising technology) are confronted with the daily task of determining which of the millions of transactions being processed between consumers and merchants are real and which are fraudulent. It is estimated that the sum of all worldwide credit card fraud is $5.55 billion annually. “Credit Card Statistics,” available at http://www.statisticbrain.com/credit-card-fraud-statistics/_(last visited May 15, 2015).

Numerous techniques are utilized by payment instrument issuing institutions to detect fraudulent transactions. Payment instrument issuing institutions watch, for example, a small purchase followed immediately by a larger one, a purchase out of character with the usual buying habits of the individual, substantial online purchases, as well as utilize a variety of other techniques in the detection of fraudulent transactions. Many of the existing techniques have flaws inherent in them, and payment instrument issuing institutions constantly search for new and improved ways to avoid fraud. The existing techniques for registration-based fraud detection suffer from payment instrument holders that are wary, negligent in registering, or intentionally avoid registration in fraud prevention programs, avoiding the benefits they provide.

One advantage presented to payment instrument issuing institutions in the fight against fraud is the computer. Every payment instrument transaction processed has a large amount of data associated with it, including but not limited to, a location of the transaction, payment instrument identification associated with the transaction, home address of the payment instrument holder, whether the transaction is device-present or not, etc., all of which is available to the payment instrument institution via computers and associated network/internet connections. Since payment instrument issuing institutions are presented with such a wide variety of data in every transaction processed on a regular basis, it is possible to utilize such data in new and creative ways to avoid fraud.

Accordingly, there is a need for a method, system, and computer program product which offers an alternative way of preventing fraudulent payment instrument transactions and data mining without requiring explicit registration.

### SUMMARY OF THE DISCLOSURE

The present disclosure provides various methods, systems, and computer program products for associating one or more payment instrument identifications utilized by an individual with one or more geolocation devices via a comparison by a specialized computing device of one or more graphical representations of geolocation history associated with one or more geolocation devices, and one or more graphical representations of spending history by the individual. After completion, the advantages of an association of one or more payment instrument identifications utilized by an individual with a geolocation device are numerous, and include significant advantages for fraud prevention, data mining, and others. A further advantage presented, is that the presently disclosed methods, systems, and computer program products do not require explicit registration of payment instrument holders.

In accordance with a first aspect of the present disclosure, a specialized computing device is used to link one or more geolocation devices configured to transmit recognition IDs held by an individual with a payment instrument identification utilized by the individual via a comparison of one or more graphical representations of geolocation history associated with the one or more geolocation devices with a graphical representation of spending history by the individual. In an embodiment of the disclosure, the one or more graphical representations of geolocation history and the graphical representation of spending history of the individual are computerized three-dimensional graphs having an x-axis, a y-axis, and a z-axis. In a further embodiment, the x-axis or the y-axis of the three-dimensional graphs represents latitude, and another of the x-axis or y-axis represents longitude. The specialized computing device receives from a first database one or more graphical representations of geolocation history associated with one or more geolocation devices configured to transmit recognition IDs. The one or more graphical representations of geolocation history indicate locations visited by the one or more geolocation devices during a given timeframe and may be associated with exactly one geolocation device or more. The given timeframe may equal in various embodiments 1 hour, 1 day, 3 days, 1 week, and 1 month, or any other greater or lesser timeframe. The one or more graphical representations of geolocation history are stored into memory associated with the specialized computing device. In an embodiment of the disclosure, the z-axis of the one or more graphical representations of geolocation history indicates how often the geolocation device was present at multiple given locations over the given timeframe. The specialized computing device receives from a user of the presently disclosed method, system, and computer program product the payment instrument identification associated with the payment instrument utilized by the individual to be linked with the one or more geolocation devices. In various embodiments, the user may be human or a daemon instructed to access the presently disclosed system, method, and computer program product automatically or semi-automatically at certain times. The specialized computing device accesses a second database using the payment instrument identification received from the user and receives the graphical representation of spending history associated with the payment instrument identification, the graphical representation of the spending history indicating locations where device-present transactions associated with the payment instrument identification were completed and a number of transactions completed at multiple given locations of device-present transactions during the given timeframe. In an embodiment of the disclosure, the z-axis of the graphical representation of spending history indicates a number of transactions completed at multiple given locations of the device-present transactions over the given timeframe. In a further embodiment of the disclosure, after receiving the graphical representation of spending history, the specialized computing device determines if a number of transactions completed at any one location of the multiple given locations exceeds how often the geolocation device was present at one location of the multiple given locations, and, if so, the specialized computing device automatically determines the payment instrument identification is not associated with the geolocation devices. The specialized computing device calculates a volume difference between the graphical representation of spending history and exactly one graphical representation of geolocation history of the one or more graphical representations of geolocation history. Thereafter, the specialized computing device determines if the volume difference between the graphical representation of spending history and the exactly one graphical representation of geolocation history is below a match threshold and, if so, linking the payment instrument identification with the one or more geolocation devices transmitting the recognition IDs. The linkage of the payment instrument identification with one or more geolocation devices may be used by the specialized computing device to detect fraud in future payment transactions completed by the payment instrument associated with the payment instrument identification. In an embodiment, the volume difference between the graphical representation of spending history and the exactly one graphical representation of geolocation history is calculated as an absolute value of a volume of the exactly one graphical representation of geolocation history minus a volume of the graphical representation of spending history. In a further embodiment, if there ise more than one graphical representation of geolocation histories available, a unique volume difference of a remainder of the graphical representations of geolocation history and the graphical representation of spending history is calculated.

Various aspects of these embodiments can be interwoven to provide for more efficient improvement of the quality of data available via web mapping services. In addition to the above aspects of the present disclosure, additional aspects, objects, features, and advantages will be apparent from the embodiments presented in the following description and in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a block diagram 100 displaying the process of completing a payment instrument transaction in an embodiment of the disclosure.

FIG. 2 illustrates a flow chart 200 displaying basic steps of a method comprising an embodiment of the disclosure.

FIG. 3 illustrates a graphical representation of geolocation history 300 associated with one or more geolocation devices, in an embodiment of the disclosure.

FIG. 4 illustrates a graphical representation of spending history 400 associated with a payment instrument identification, in an embodiment of the disclosure.

FIG. 5 illustrates a graphical representation of a superimposition 500 of a topographical surface 340 associated with a graphical representation of geolocation history superimposed with a topographical surface 440 associated with a graphical representation of spending history, in an embodiment of the disclosure.

### DETAILED DESCRIPTION OF THE EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

As will be appreciated by one skilled in the art, the present disclosure may be embodied as a system, method, or computer program product. Accordingly, the present disclosure may take the form of an entirely hardware embodiment, an entirely software embodiment (including firmware, resident software, micro-code, etc.) or an embodiment combining software and hardware aspects that may generally be referred to herein as a “server,” “device,” “computing device,” “general purpose computer,” “computer device,” or “system.” In an embodiment, a “specialized computing device” may be utilized providing functionality in connection with the presently disclosed system, method, and computer program apparatus. As is commonly known in the art, such devices are associated with a single or multiple processors or CPUs, which are specially programmed in order to perform a task at hand. Multiple computer systems may also be networked together via a motherboard, system bus, in a local-area network, or via the internet to perform the same function. Furthermore, the present disclosure may take the form of a computer program product embodied in any tangible medium of expression having computer usable program code embodied in the medium. Computer program code (or “computer program instructions”) for carrying out operations of the present disclosure may operate on any or all of a “server,” “device,” “computing device,” “general purpose computer,” “computer device,” “system,” or “specialized computing device” discussed herein. Computer program code for carrying out operations of the present disclosure may be written in any combination of one or more programming languages, including an object-oriented programming language such as Java, Smalltalk, C++, or the like and conventional procedural programming languages, such as Visual Basic, “C,” or similar programming languages. After-arising programming languages are contemplated as well.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

Providing of such computer program instructions to the “server,” “device,” “computing device,” “general purpose computer,” “computer device,” “system,” or “specialized computing device” causes a machine to be produced, such that the computer program instructions when executed create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the “server,” “device,” “computing device,” “general purpose computer,” “computer device,” “system,” or “specialized computing device” or other programmable apparatus to produce a computer-implemented process such that the instructions which execute on the “server,” “device,” “computing device,” “general purpose computer,” “computer device,” “system,” or “specialized computing device” or other programmable apparatus to provide processes for implementing the functions/acts specified in the flowchart and/or block diagram block or blocks. The large amounts of data being processed by the presently disclosed systems, methods, and computer program products indicate a “server,” “device,” “computing device,” “general purpose computer,” “computer device,” “system,” and/or “specialized computing device” is a necessary element of the present disclosure.

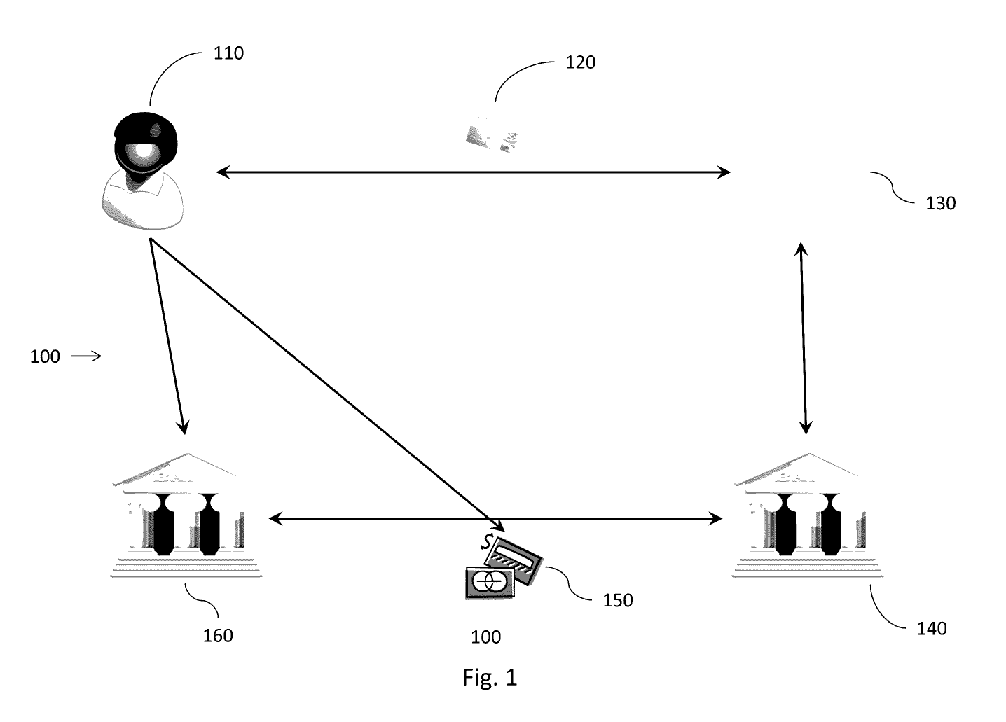

Referring to FIG. 1, there is shown a block diagram 100 displaying the general process of completing a payment transaction with a payment instrument in an embodiment of the disclosure. A customer (also known as a payment instrument holder) 110 desires to purchase a good or service from a merchant or other business 130. The merchant or other business 130 may be a mobile business or otherwise. The customer 110 is carrying a personal computing device (also known herein as a “geolocation device”) as he or she shops (not shown here). Personal computing devices that may be used as geolocation devices include cellular telephones, pagers, lap-tops, personal navigation devices, tablets, personal digital assistants, or other similar devices. Customer 110 presents a “payment instrument” 120 (such as a credit card, debit card, ATM card, CHIP card, electronic wallet, transponder device, NFC-enabled smart phone, PIN transaction, or similar current or after-arising technology) to the merchant or other business 130 for payment in connection with a payment transaction. The merchant or other business 130 utilizes his or her transaction acquiring device (also not shown) to communicate with a merchant acquiring institution or “Acquirer” 140 seeking approval for this transaction. In an embodiment of the disclosure, the transaction acquiring device may be a mobile payment receiving device, as used by a mobile business. The Acquirer 140 transmits an authorization message formatted pursuant to ISO 8583 (which is incorporated here in its entirety) or its present or after-arising equivalent. The authorization message contains “details” such as, at least, the customer's (110) payment instrument holder account identification (or “payment instrument holder identification,” the payment instrument holder identification being in various embodiments a sixteen digit number (such as 1234-5555-6789-5555, unique alphanumeric combination, or other manner of unique identification of a payment instrument for unique identification), other account information, amount of the transaction, time the transaction was initiated, etc., such information utilized in obtaining approval for the transaction. The transmission is made via a payment instrument network 150 to a payment instrument issuing institution 160 associated with the payment instrument 120. Other “details” of a completed payment transaction are transmitted as well, including the preceding as well as (but not limited to) the geolocation where a payment transaction is occurring, the time the transaction was approved, and other related data. Should approval be appropriate, the payment instrument issuing institution 160 transmits an approval message via the payment instrument network 150 to the Acquirer 140 who then retransmits the approval message to the merchant 130, who thusly learns the sale is complete. As previously discussed, the approval message is transmitted in formatting consistent with ISO 8583 or its present or after-arising equivalent.

In connection with the present disclosure, the customer 110 (or potential customer) broadcasts his or her geolocation using his or her personal computing device before, during, or after a payment transaction to the payment instrument issuing institution 160 and/or the payment instrument network 150 via a number of means as detailed below. Other customers, or potential customers (not shown here) also carrying personal computing devices broadcast their own geolocation at the same time. The broadcast of geolocation can take place in active or passive fashion. In one embodiment, the broadcasting of geolocation of personal computing devices is a passive process, not requiring an active choice to enroll in a program designed to track geolocations. The payment instrument issuing institution 160 and payment instrument network 150 are able to recognize the geolocation of a personal computing device via a “recognition ID,” which could include a phone number utilized by the personal computing device within a telephone network or over the internet, a Bluetooth identification, a Wi-Fi login, a device ID, a social media handle, a MAC address, or any other means of passively determining geolocation of a personal computing device without express consent of the holder of the personal computing device. These recognition IDs are obtained through observation of social media, SMS messages, a geolocation ping, logging into a public hot-spot, or other currently existing or after-arising technology. As a means of non-limiting example, the customer 110 transmits geolocation passively (without opt-in) via use of Bluetooth, Wi-Fi, MAC Address, phone cookie, cell tower ping, or activation of a link on a cell phone application. Alternately, in an embodiment of the disclosure one or more customers 110 opts-in to transmit geolocation via GPS on a mobile computing device via, for example, checking-in, offer redemption, sending an SMS requesting consent, answering a telephone call requesting consent, registration with a local node, etc., in order to allow more effective means of tracking of geolocation. In such an event, if consent is provided, a GPS location of the personal computing device may be provided statically or dynamically. These types of geolocation data may be updated continuously, at five minute intervals, at ten minute intervals, at hourly intervals, or according to any other period.

During operation of an embodiment of the disclosure, a computing system (such as a “specialized computing device”) associated with a matching database operated by the payment instrument issuing institution 160 or the payment instrument network 150 receives a number of recognition IDs (from one to billions), with each execution indicating locations associated with recognition IDs of personal computing devices associated with one customer 110 or many potential customers. The purpose of the present disclosure is to utilize the passively (or actively) collected locations of personal computing devices (or “recognition IDs”) in the form of one or more graphical representations of geolocation history associated with one or more geolocation devices transmitting recognition IDs, in combination with information on completed payment transactions associated with payment instruments in the form of graphical representations of spending history associated with payment instrument identifications to allow linking of the payment instrument identifications with one or more geolocation devices, which, in turn, allows linking of locations, merchant names, and payment instruments used to make purchases, etc., providing various benefits to payment instrument holders, merchants, and the payment instrument institutions alike.

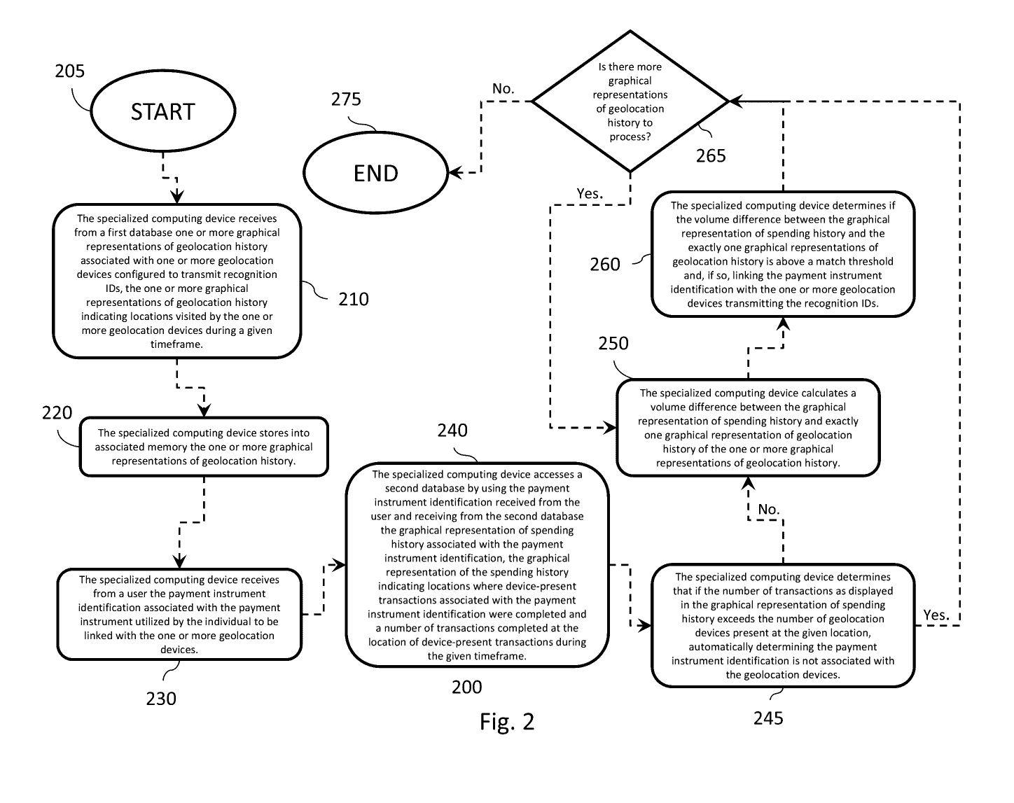

Referring to FIG. 2, shown is a flow chart 200 displaying basic steps of a method comprising an embodiment of the disclosure. The steps disclosed in the flow chart 200 may also be utilized in connection with a system or computer program product, as discussed elsewhere herein. The steps may be performed in any order, and with or without certain steps. Flow chart 200 shows steps of the method by which a specialized computing device is used to link one or more geolocation devices configured to transmit recognition IDs held by an individual with a payment instrument identification associated with a payment instrument utilized by the same individual via a comparison of one or more graphical representations of geolocation history associated with the one or more geolocation devices with a graphical representation of spending history associated with the payment instrument, the spending history by the individual. Execution begins at “START,” step 205. At step 210 the specialized computing device receives from a first computer database one or more graphical representations of geolocation history associated with one or more geolocation devices configured to transmit recognition IDs, the one or more graphical representations of geolocation history indicating locations visited by the one or more geolocation devices during a given timeframe. In various embodiments of the disclosure, each graphical representation of geolocation history may be associated with exactly one geolocation device or more than one geolocation devices. If graphical representations of geolocation history are each associated with more than one geolocation device, the graphical representation of geolocation history indicates locations visited by all associated geolocation devices during the given timeframe.

In an embodiment of the disclosure the one or more graphical representations of geolocation history may be computerized three-dimensional graphs having an x-axis, y-axis, and z-axis. The x-axis or the y-axis may represent latitude and another of the x-axis and y-axis may represent longitude, while the z-axis may represent how often the geolocation device was present at multiple given locations over the given timeframe. The given timeframe the graphical representations of geolocation history may, for example, track a motion of the geolocation device, may be, for example, 1 hour, 1 day, 3 days, 1 week, 1 month, 6 months, 1 year, or any other timeframe.

At step 220 the specialized computing device stores into associated memory the one or more graphical representations of geolocation history. In various embodiments, storing into memory the one or more graphical representations of geolocation history allows for more efficient and faster processing of the relevant data. At step 230, the specialized computing device receives from a user the payment instrument identification associated with the payment instrument utilized by the individual to be linked with the one or more geolocation devices. In other embodiments, instead of a user calling for execution of the presently disclosed system, method, and computer program product, a daemon may call for execution, or execution simply repeats on a periodic basis as was previously selected by an administrator or other individual. At step 240, the specialized computing device accesses a second database with the payment instrument identification previously received, and, in response, receives from the second database the graphical representation of the spending history associated with the payment instrument identification. The graphical representation of the spending history indicates locations where device-present transactions associated with the payment instrument identification were completed and a number of transactions completed at the location of device-present transactions. In an embodiment of the disclosure, the graphical representation of spending history may be a three-dimensional graph having an x-axis, y-axis, and z-axis. The x-axis or the y-axis may represent latitude and the other of the x-axis and y-axis may represent longitude. The z-axis of the graphical representation of spending history may indicate a number of transactions (or device-present transactions) completed at a given location of multiple given locations on the three-dimensional graph over the given timeframe.

After step 240, at step 245 optionally in an embodiment of the disclosure a determination may be made whether or not a number of transactions completed at any one location as displayed in the graphical representation of spending history of multiple given locations exceeds how often the geolocation device was present at the any one location. If so, the specialized computing device automatically determines the payment instrument identification is not associated with the geolocation device. Performance of such a step helps reduce processing time required for execution of the presently disclosed system, method, and computer program product. If multiple geolocation devices are being considered, the same step 240 may be performed with regard to the multiple geolocation devices.

At step 250, a volume difference is calculated between the graphical representation of spending history and exactly one graphical representation of geolocation history of the one or more graphical representations of geolocation history. The “volume difference” is calculated in any number of ways, including via a subtraction of the graphical representation of spending history from the exactly one graphical representation of geolocation history. In an embodiment of the disclosure, the volume difference is calculated as an absolute value of a volume of the exactly one graphical representation of graphical history minus a volume of the graphical representation of spending history. The volume of each graphical representation may be calculated via utilization of a calculus function, or calculated in other ways, as known by one of skill in the art. At step 260, the specialized computing device determines if the volume difference between the graphical representation of spending history and the exactly one graphical representation of geolocation history is below a match threshold. The volume difference may be, in such an embodiment, any real, positive number relied upon. In another embodiment, the “match threshold” may be, for example, in a range of percentages, for example 65%-80% (e.g. 75%), a corresponding real number in the same range, or any other. In an embodiment of the disclosure, the match threshold may be utilized as follows:

$$Match Threshold \geq \frac{\begin{matrix}Volume of Graphical \\ Representation of Spending History\end{matrix}}{\begin{matrix}Volume of Graphical \\ Representation of Geolocation History\end{matrix}}$$

If this is calculated to be true by the specialized computing device, the payment instrument identification is linked with the one or more geolocation devices transmitting the recognition IDs. In an embodiment considering more than one geolocation device, each graphical representation of geolocation history is considered independently as described above. Such data linkage may then be provided to a user, daemon, or other requester. Such data may be returned to the requester, and execution may terminate 275.

At step 265, in an embodiment of the disclosure a determination is made whether there are more graphical representations of geolocation history to process. If so, execution may return to 250, to calculate a new volume difference (or, in a further embodiment, to step 245 to determine whether the number of transactions displayed in the graphical representation of spending history exceeds the number of geolocation devices present at the given location, and, if so, automatically determining the payment instrument identification is not associated with the geolocation devices), or return after step 265 to any other step as displayed within FIG. 2. At step 275, execution terminates.

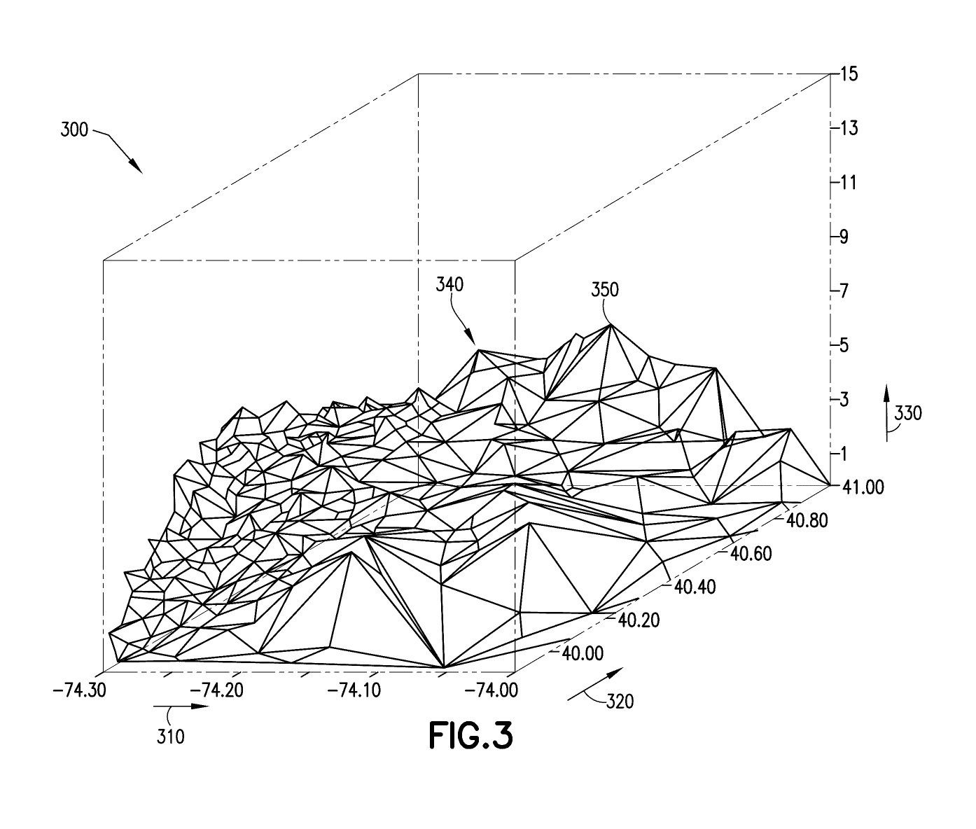

Referring to FIG. 3, shown is a graphical representation of geolocation history 300 associated with a geolocation device configured to transmit a recognition ID, in an embodiment of the disclosure. The graphical representation of geolocation history associated with the geolocation device is displayed as a topographical surface 340. X-axis 310 displays longitude associated with the graphical representation of geolocation history 300. Y-axis 320 displays latitude associated with the graphical representation of geolocation history 300. In an embodiment of the disclosure, Z-axis 330 displays a number of locations visited by the geolocation device during a given timeframe (the locations as described by a point on the x-axis 310 and the y-axis 320) of multiple given locations (as associated with different points across the topographical surface 340). In this embodiment, therefore, points on the topographical surface 340, such as point 350 describe a number of times a geolocation device was present at point 350 (specifically, 6 times) at coordinates (41.00, −74.15) during the given timeframe. In alternative embodiments of the disclosure, the z-axis 330 represents a number of geolocation devices present at a given location (if the graphical representation of geolocation history is associated with more than one geolocation device), an amount of time spent at locations by a single geolocation device (in minutes, hours, days, or any other timeframe) or cumulative time spent (in minutes, hours, days, or by any other measurement of time) by multiple geolocation devices at the multiple given locations described by x-axis 310 and y-axis 320. The z-axis 330 may have other meanings in other embodiments of the disclosure.

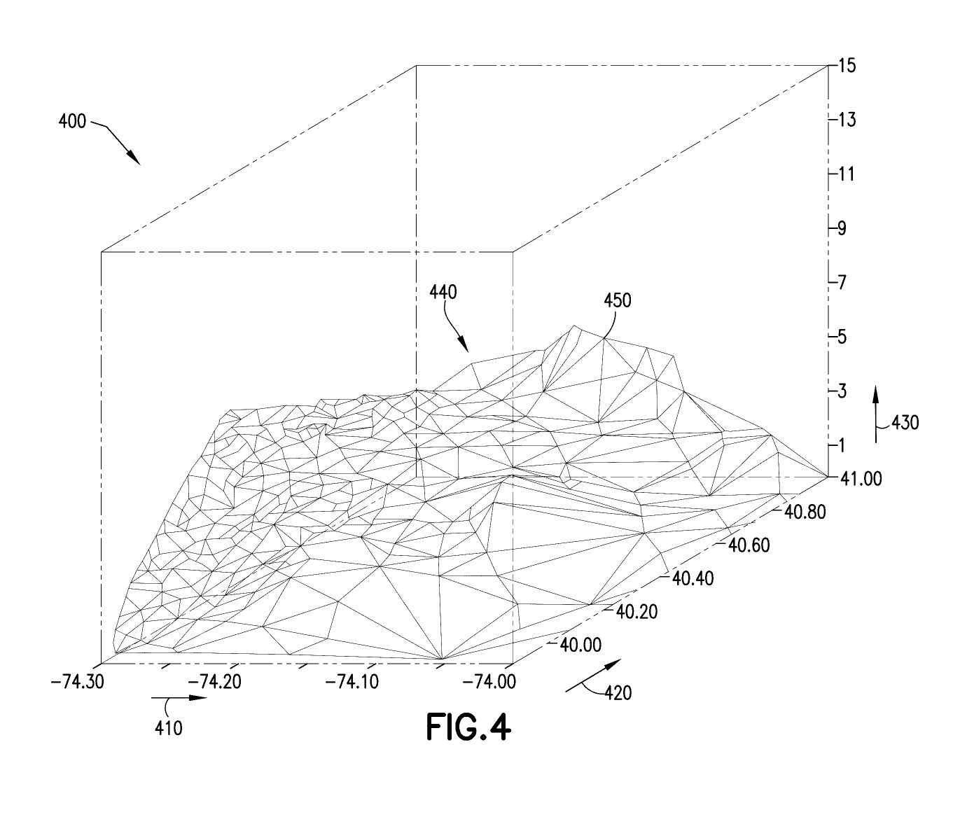

Referring to FIG. 4, shown is a graphical representation of spending history 400 associated with a payment instrument identification (which is, in turn, associated with a payment instrument), in an embodiment of the disclosure. The graphical representation of spending history is again displayed as a topographical surface 440. X-axis 410 displays longitude associated with the graphical representation of spending history 400. Y-axis 420 displays latitude associated with the graphical representation of spending history 400. In an embodiment of the disclosure, Z-axis 430 displays a number of device-present transactions completed at any one location (the one location as described by a point on the x-axis 410 and the y-axis 420) of multiple given locations (as associated with different points across the topographical surface 440). For example, point 450 indicates that at coordinates (41.00, −74.15), 5 device-present transactions were completed. Such location may be, for example, associated with a small to medium size merchant and one payment instrument holder, or multiple payment instrument holders. In an alternative embodiment, z-axis 430 represents a total currency amount of transactions completed at the multiple given locations of device-present transactions. The Z-axis 430 may have other meanings in other embodiments of the disclosure.

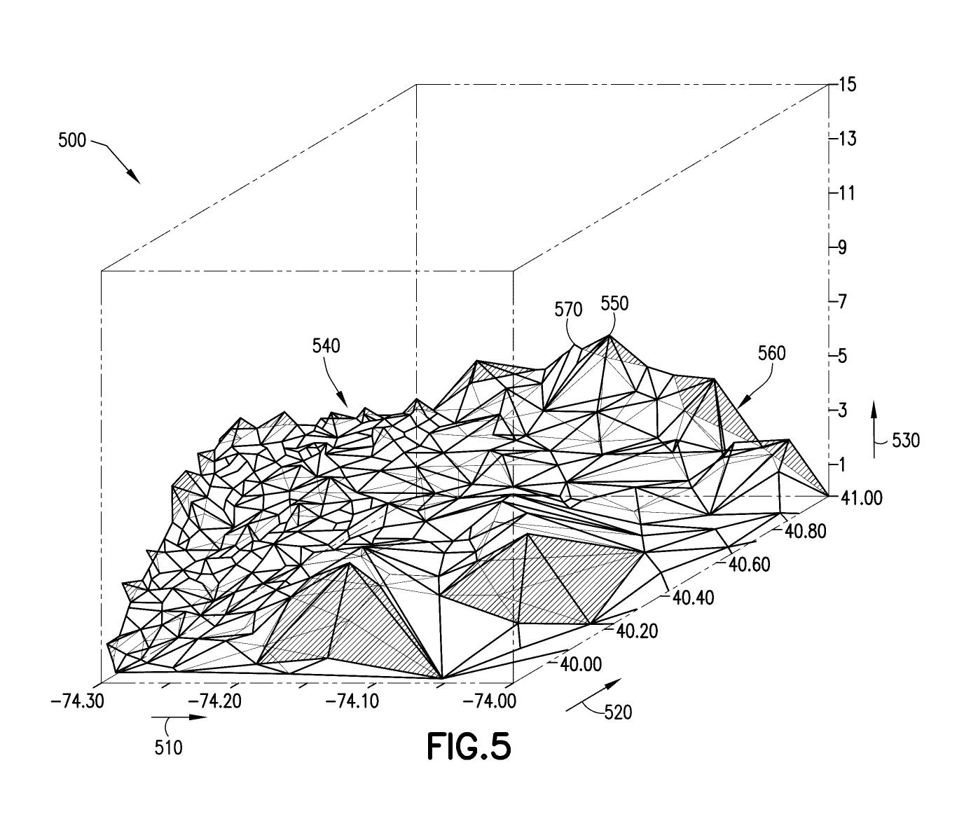

Referring to FIG. 5, shown is a graphical representation of a superimposition 500 of a topographical surface 340 (as shown on FIG. 3) associated with exactly one graphical representation of geolocation history superimposed with a topographical surface 440 (as shown on FIG. 4) associated with a graphical representation of spending history, in an embodiment of the disclosure. Such a superimposition 500 as displayed in FIG. 5 may be used in an embodiment of the disclosure to calculate a volume difference between the topographical surfaces 340 and 440. Both topographical surfaces 340 and 440 are shown on a computerized three-dimensional graph of the superimposition having an x-axis 510, a y-axis 520, and a z-axis 530. As with previous figures, x-axis 510 displays longitude associated with the topographical surfaces 340, 440 and y-axis 520 displays latitude associated with the topographical surfaces 340, 440. Z-axis 530 may be understood to display units associated with either a z-axis 330 of topographical surface 340 (as shown on FIG. 3) or a z-axis 430 of topographical surface 440 (as shown on FIG. 4). After the superimposition 500 of topographical surfaces 340 and 440, volumes of each are calculated (such as by a calculus function, or any other means known by a person of skill in the art), and a volume difference 560 between topographical surfaces 340 and 440 calculated. The volume difference 560 is then utilized, as discussed elsewhere herein, to determine whether to link the payment instrument identification with the one or more geolocation devices transmitting recognition IDs. In an embodiment of the disclosure, the absolute value of the volume difference is relied upon to perform the same function. In a further embodiment of the disclosure, if points such as point 550 exist, and a number of transactions completed at any one location exceeds a number of geolocation devices present at the location, the specialized computing device automatically determines the payment instrument identification is not associated with the geolocation device or geolocation devices in question. Further processing is thereafter not needed.

As would be appreciated by one of skill in the art, the present disclosure will comply with all relevant state, federal, and international laws regarding data privacy and otherwise. The primary intent of the present disclosure is directed to fraud prevention and maintenance of internal statistics.

What is claimed is:

1. A method of using a specialized computing device to link one or more geolocation devices configured to transmit recognition IDs held by an individual with a payment instrument identification associated with a payment instrument utilized by the individual via a comparison of one or more graphical representations of geolocation history associated with the one or more geolocation devices and a graphical representation of spending history by the individual, the method comprising:
Receiving by the specialized computing device from a first database one or more graphical representations of geolocation history associated with one or more geolocation devices configured to transmit recognition IDs, the one or more graphical representations of geolocation history indicating locations visited by the one or more geolocation devices during a given timeframe;
Storing the one or more graphical representations of geolocation history into memory associated with the specialized computing device;
Receiving from a user the payment instrument identification associated with the payment instrument utilized by the individual to be linked with the one or more geolocation devices;
Accessing a second database by the specialized computing device using the payment instrument identification received from the user and receiving from the second database the graphical representation of spending history associated with the payment instrument identification, the graphical representation of the spending history indicating locations where device-present transactions associated with the payment instrument identification were completed and a number of transactions completed at multiple given locations of device-present transactions during the given timeframe;
Calculating by the specialized computing device a volume difference between the graphical representation of spending history and exactly one graphical representation of geolocation history of the one or more graphical representations of geolocation history; and
Determining by the specialized computing device if the volume difference between the graphical representation of spending history and the exactly one graphical representation of geolocation history is below a match threshold and, if so, linking the payment instrument identification with the one or more geolocation devices transmitting the recognition IDs.

2. The method of claim 1, wherein the one or more graphical representations of geolocation history and the graphical representation of spending history of the individual are computerized three-dimensional graphs having an x-axis, a y-axis, and a z-axis.

3. The method of claim 2, wherein the x-axis or the y-axis of the three-dimensional graphs represents latitude and an other of the x-axis or the y-axis represents longitude.

4. The method of claim 3, wherein the z-axis of the one or more graphical representations of geolocation history indicates how often the geolocation device was present at multiple given locations over the given timeframe and the z-axis of the graphical representation of spending history indicates a number of transactions completed at multiple given locations of the device-present transactions over the given timeframe.

5. The method of claim 4, wherein if a number of transactions completed at any one location of the multiple given locations exceeds how often the geolocation device was present at one location of the multiple given locations, automatically determining by the specialized computing device the payment instrument identification is not associated with the geolocation devices.

6. The method of claim 1, wherein the volume difference between the graphical representation of spending history and the exactly one graphical representation of geolocation history is calculated as an absolute value of a volume of the exactly one graphical representation of geolocation history minus a volume of the graphical representation of spending history.

7. The method of claim 1, wherein if there are more than one graphical representations of geolocation history, calculating a unique volume difference of a remainder of the graphical representations of geolocation history and the graphical representation of spending history.

8. The method of claim 1, wherein each graphical representation of geolocation history is associated with exactly one geolocation device.

9. The method of claim 1, wherein the given timeframe of the one or more graphical representations of geolocation history and the graphical representation of spending history equal selectively one of the following: 1 hour, 1 day, 3 days, 1 week, and 1 month.

10. The method of claim 1, wherein the specialized computing device uses the payment instrument identification linked with the one or more geolocation devices to detect fraud in future payment transactions completed by the payment instrument associated with the payment instrument identification.

11. A system using a specialized computing device to link one or more geolocation devices transmitted to transmit recognition IDs held by an individual with a payment instrument identification associated with a payment instrument utilized by the individual via a comparison of one or more graphical representations of geolocation history associated with the one or more geolocation devices and a graphical representation of spending history by the individual, the system comprising:
The specialized computing device receives from a first database one or more graphical representations of geolocation history associated with one or more geolocation devices configured to transmit recognition IDs, the one or more graphical representations of geolocation history indicating locations visited by the one or more geolocation devices during a given timeframe;
Memory associated with the specialized computing device stores the one or more graphical representations of geolocation history into memory associated with the specialized computing device;
The specialized computing device receives from a user the payment instrument identification associated with the payment instrument utilized by the individual to be linked with the one or more geolocation devices;
The specialized computing device accesses a second database using the payment instrument identification received from the user and receiving from the second database the graphical representation of spending history associated with the payment instrument identification, the graphical representation of the spending history indicating locations where device-present transactions associated with the payment instrument identification were completed and a number of transactions completed at multiple given locations of device-present transactions during the given timeframe;
The specialized computing device calculates a volume difference between the graphical representation of spending history and exactly one graphical representation of geolocation history of the one or more graphical representations of geolocation history; and
The specialized computing device determines if the volume difference between the graphical representation of spending history and the exactly one graphical representation of geolocation history is below a match threshold and, if so, linking the payment instrument identification with the one or more geolocation devices transmitting the recognition IDs.

12. The system of claim 11, wherein the one or more graphical representations of geolocation history and the graphical representation of spending history of the individual are computerized three-dimensional graphs having an x-axis, a y-axis, and a z-axis.

13. The system of claim 12, wherein the x-axis or the y-axis of the three-dimensional graphs represents latitude and an other of the x-axis or the y-axis represents longitude.

14. The system of claim 13, wherein the z-axis of the one or more graphical representations of geolocation history indicates how often the geolocation device was present at multiple given locations over the given timeframe and the z-axis of the graphical representation of spending history indicates a number of transactions completed at multiple given locations of the device-present transactions over the given timeframe.

15. The system of claim 14, wherein if a number of transactions completed at any one location of the multiple given locations exceeds how often the geolocation device was present at one location of the multiple given locations, the specialized computing device automatically determines the payment instrument identification is not associated with the geolocation devices.

16. The system of claim 11, wherein the volume difference between the graphical representation of spending history and the exactly one graphical representation of geolocation history is calculated as an absolute value of a volume of the exactly one graphical representation of geolocation history minus a volume of the graphical representation of spending history.

17. The system of claim 11, wherein if there are more than one graphical representations of geolocation history, calculating a unique volume difference of a remainder of the graphical representations of geolocation history and the graphical representation of spending history.

18. The system of claim 11, wherein each graphical representation of geolocation history is associated with exactly one geolocation device.

19. The system of claim 11, wherein the given timeframe of the one or more graphical representations of geolocation history and the graphical representation of spending history equal selectively one of the following: 1 hour, 1 day, 3 days, 1 week, and 1 month.

20. The system of claim 11, wherein the specialized computing device uses the payment instrument identification linked with the one or more geolocation devices to detect fraud in future payment transactions completed by the payment instrument associated with the payment instrument identification.
